(19) United States
(12) Patent Application Publication
(10) Pub. No.: US 2019/0311222 A1
(43) Pub. Date: Oct. 10, 2019

(54) EVALUATION SYSTEM, EVALUATION METHOD, AND EVALUATION PROGRAM

(71) Applicant: NEC CORPORATION, Tokyo (JP)

(72) Inventors: Shinji ITO, Tokyo (JP); Akihiro YABE, Tokyo (JP); Ryohei FUJIMAKI, Tokyo (JP)

(73) Assignee: NEC CORPORATION, Tokyo (JP)

(21) Appl. No.: 16/345,496

(22) PCT Filed: Oct. 18, 2017
(86) PCT No.: PCT/JP2017/037666

§ 371 Date: Apr. 26, 2019

(30) Foreign Application Priority Data
Oct. 28, 2016 (JP) 2016-211438

(51) Int. Cl. G06K 9/62; G06N 7/00

(52) U.S. Cl. CPC G06K 9/6231; G06N 7/005; G06K 9/6256

(57) ABSTRACT

An evaluation system 80 includes an evaluation unit 81 for evaluating, when there is a prediction model estimated using data generated from the true model, the optimal solution calculated from the prediction model in consideration of bias generated between evaluation based on the prediction model and evaluation based on the true model.

### TECHNICAL FIELD

The present invention relates to an evaluation system, an evaluation method, and an evaluation program for evaluating contents determined on the basis of a prediction model.

### BACKGROUND ART

Generally the true model is unknown, and thus prediction models are estimated on the basis of data generated from the true model. When a prediction model can be estimated, a future state can be predicted on the basis of the model, which also allows various strategies to be planned out on the basis of that state.

Patent Literature 1 describes an ordering plan determination device that determines an order placement plan of products. The ordering plan determination device described in Patent Literature 1 calculates a combination of a price and an order quantity of a commodity that maximizes profit by predicting demand for the commodity of each price and solving an optimization problem of an objective function that uses the price and the order quantity as an input using the predicted demand and the profit as an output.

### CITATION LIST

### Patent Literature

PTL 1: Japanese Patent Application Laid-Open No. 2016-110591

### SUMMARY OF INVENTION

### Technical Problem

One of strategies based on prediction is to estimate the effect of results optimized on the basis of prediction. Specifically, a prediction model is estimated on the basis of data generated from an unknown true model, and an optimal solution is calculated from the estimated prediction model. Then, by evaluating the optimal solution using the prediction model, effects by the optimal solution are estimated.

However, the present inventors have found that when a prediction model is generated on the basis of data generated from the true model, an optimal solution is calculated from the prediction model, and this result is evaluated by the prediction model, the evaluation result is biased positively than the actual evaluation result.

For example, when a price is determined on the basis of a prediction result, simply estimating expected profit from a prediction model disadvantageously generates a difference from the true profit. Especially in this case, an expected profit which is more profitable is calculated from the viewpoint of the average value. This will be specifically described below.

It is assumed that M products are available and that an index thereof is denoted as mϵ{1, . . . , M}. The sales quantity qϵR^{M} at a price pϵR^{M} is calculated from a model expressed by, for example, the following formula 1.

$$\begin{matrix}[ Math 1 ] & \\ q = {\sum }_{d = 1}^{D} {θ}_{d}^{*} {ψ}_{d} ( p ) = ϵ , ϵ \sim N ( 0 , \sum ) & ( formula 1 )\end{matrix}$$

In formula 1, {ψ_{d}: R^{M}→R^{M}}^{D}_{d=1} is a fixed basis function, and {θ*_{d}}⊆R is the true coefficient. Where θ*=[θ*₁, . . . , θ*_{d}]^{T}ϵR^{D} and ψ(p)=[ψ₁(p), . . . , ψ_{d}(p)], the total sales is given by the following formula 2.

$$\begin{matrix}[ Math 2 ] & \\ {p}^{T} ( {\sum }_{d = 1}^{D} {θ}_{d}^{*} {ψ}_{d} ( p ) + ϵ ) = {θ}^{* T} ( {ψ ( p )}^{T} p ) + {p}^{T} ϵ & ( formula 2 )\end{matrix}$$

When an expected value of formula 2 is denoted as f(p, θ*), the expected value is expressed as in the following formula 3, for example.

[Math 3]

ƒ(p,θ*)= [symbol] ₆[θ*^{T}(ψ(p)^{T}p)+p^{T}ϵ]=θ*^{T}(ψ(p)^{T}p) (formula 3)

Here, under the constraint of pϵP, the problem of maximizing the expected total sales is expressed by the following formula 4.

[Math 4]

Maximize ƒ(p,θ*)

subject to pϵP (formula 4)

However, in the actual situation, it is not possible to know the true coefficient θ*. Therefore, in general, θ* is replaced by an estimated value θ-hat (θ superscripted by \hat{ }), and an optimal strategy represented by the following formula 5 is calculated.

$$\begin{matrix}[ Math 5 ] & \\ p ( \hat{θ} ) := {ar g max}_{p ∈ P} f ( p , \hat{θ} ) & ( formula 5 )\end{matrix}$$

If θ-hat is an unbiased evaluator, f(p, θ-hat) is an unbiased evaluator of f(p, θ*) for every pϵP. Therefore, the optimal value f(p(θ-hat), θ-hat) can also be considered as an evaluator of the expected true total sales f(p(θ-hat), θ*) without bias. However, in reality this does not apply, but the relationship expressed in the following formula 6 holds.

[Math 6]

[symbol]

_{\hat{θ}}[ƒ(p(\check{θ}),θ*)]≤ƒ(p(θ*),θ*)= [symbol] _{\hat{θ}}[ƒ(p(θ*,\hat{θ}))]≤ [symbol] _{\hat{θ}}[ƒ(p(\hat{θ}),\hat{θ})] (formula 6)

Formula 6 means that even when there is no bias in the θ-hat, f(p(θ-hat), θ-hat) may not be an evaluator of f(p(θ-hat), θ*). In order to establish unbiased f(p(θ-hat), θ*), it may be necessary to evaluate the bias terms expressed in the following formula 7.

[Math 7]

[symbol]

_{\hat{θ}}[ƒ(p(\hat{θ}),\hat{θ})]− [symbol] _{\hat{θ}}[ƒ(p(\hat{θ}),θ*)] (formula 7)

Therefore, it is an object of the present invention to provide an evaluation system, an evaluation method, and an evaluation program capable of evaluating an optimal solution based on prediction theoretically without generating a bias.

### Solution to Problem

An evaluation system according to the present invention includes an evaluation unit which evaluates, when there is a prediction model estimated using data generated from the true model, the optimal solution calculated from the prediction model in consideration of bias generated between evaluation based on the prediction model and evaluation based on the true model.

An evaluation method according to the present invention includes evaluating, when there is a prediction model estimated using data generated from the true model, the optimal solution calculated from the prediction model in consideration of bias generated between evaluation based on the prediction model and evaluation based on the true model.

An evaluation program according to the present invention causes a computer to execute evaluation processing for evaluating, when there is a prediction model estimated using data generated from the true model, the optimal solution calculated from the prediction model in consideration of bias generated between evaluation based on the prediction model and evaluation based on the true model.

### Advantageous Effects of Invention

According to the present invention, an optimal solution based on prediction can be evaluated theoretically without generating a bias.

### BRIEF DESCRIPTION OF DRAWINGS

FIG. 1 It depicts a block diagram illustrating an exemplary configuration of a first exemplary embodiment of an evaluation system of the present invention.

FIG. 2 It depicts a flowchart illustrating exemplary operation of the evaluation system of the first exemplary embodiment.

FIG. 3 It depicts a flowchart illustrating exemplary operation of an evaluation system of a variation of the first exemplary embodiment.

FIG. 4 It depicts a flowchart illustrating exemplary operation of an evaluation system of a second exemplary embodiment.

FIG. 5 It depicts a flowchart illustrating other exemplary operation of the evaluation system of the second exemplary embodiment.

FIG. 6 It depicts a block diagram illustrating an overview of an evaluation system of the present invention.

FIG. 7 It depicts a schematic block diagram illustrating a configuration of a computer according to at least one of the exemplary embodiments.

### DESCRIPTION OF EMBODIMENTS

First, symbols used in the following description will be explained. The symbol θϵR^{p} denotes a parameter. The symbol Z denotes a set of feasible solutions. The function f: Z×R^{p}→R is an objective function. The solution z(θ) is the optimal solution of the objective function f(z, θ).

$$\begin{matrix}[ Math 8 ] & \\ z ( θ ) ∈ {arg max}_{z ∈ Z} f ( z , θ ) & \end{matrix}$$

A symbol θ* denotes a true coefficient, and θ-hat denotes an estimated parameter (random value). In addition, Θ denotes a set of θϵR^{p} for which z(θ) is uniquely determined.

$$\begin{matrix}[ Math 9 ] & \\ Θ := \{ θ ∈ {ℝ}^{p} \vert \# \{ {arg max}_{z ∈ Z} f ( z , θ ) = 1 \} \} & \end{matrix}$$

Next, problem establishment in the present invention will be described. In the present invention, what is sought for is a value of the true objective function f(z(θ-hat), θ*) based on an estimated optimal solution. However, a value of an estimated objective function f(z(θ-hat), θ-hat) based on the estimated optimal solution is not an appropriate evaluator of f(z(θ-hat), θ*). That is, there is bias as expressed in formula 8 below.

[Math 10]

[symbol]

_{\hat{θ}}[ƒ(p(\hat{θ}),θ*)]< [symbol] _{\hat{θ}}[ƒ(p(\hat{θ}),\hat{θ})] (formula 8)

Therefore, in the present invention, the goal is to establish an evaluator ρ(θ-hat) of f(z(θ-hat), θ*) that satisfies the following formula 9.

[Math 11]

[symbol]

_{\hat{θ}}[ρ(\check{θ})]= [symbol] _{\hat{θ}}[ƒ(p(\check{θ}),θ*)] (formula 9)

### First Exemplary Embodiment

First, a first exemplary embodiment of the present invention will be described. In the present exemplary embodiment, the following are assumed. First, in this exemplary embodiment, it is assumed that the optimal solution z(θ) is uniquely determined for almost every θ. For example, in the case where μ represents Lebesgue measure at R^{p}, μ(Rp¥Θ)=0 holds.

Let Z be a finite set or a compact subset of R^{d}. Also,

[Math 12]

z [symbol] (a(z),b(z))

The above represents a continuous injective function. On the basis of the above assumptions, an exemplary embodiment of the present invention will be described with reference to the drawings.

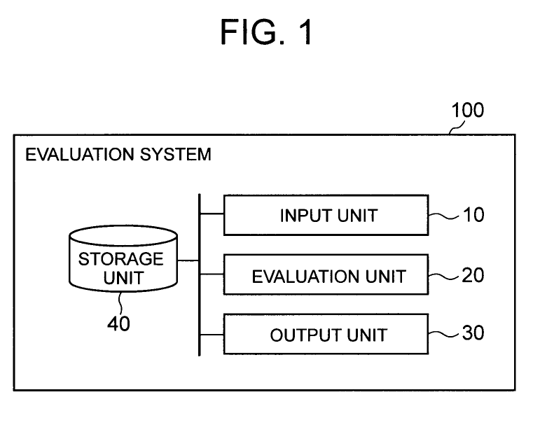

FIG. 1 depicts a block diagram illustrating an exemplary configuration of a first exemplary embodiment of an evaluation system of the present invention. An evaluation system 100 of the present exemplary embodiment includes an input unit 10, an evaluation unit 20, an output unit 30, and a storage unit 40.

The input unit 10 accepts input of various data used by the evaluation unit 20 for evaluation. The storage unit 40 stores data input from the input unit 10 and various parameters. The storage unit 40 is implemented by, for example, a magnetic disk.

The evaluation unit 20 evaluates the optimal solution, derived from prediction, on the basis of the true model assumed by a prediction model that performs the prediction.

Specifically, the evaluation unit 20 estimates θ-hat using data generated from the assumed true model θ, generates data again from a model based on the estimated θ-hat to estimate θ-hat-hat. Thereafter, this data generation process is repeated. That is, the evaluation unit 20 estimates the actual bias by repeating the calculation of bias.

In the present exemplary embodiment, a method of evaluation without bias using the bootstrap method will be described. Moreover, in this exemplary embodiment, an example of sales optimization will be described as a specific example of evaluation.

For example, let X be a set of price vectors, and let Y be a set of vectors of sales quantity. It is assumed that the price and the sales quantity follow a probability distribution F of X×Y. From a regression model {r(⋅; θ): X→Y|θϵΘ} that predicts y from the value of x, the best model for a loss function 1: X×Y×Y is given by the following formula 10.

$$\begin{matrix}[ Math 13 ] & \\ {θ}^{*} = {arg min }_{θ} 𝔼 [ 𝓁 ( x , y , r ( x ; θ ) ) \vert x , y \sim F ] & ( formula 10 )\end{matrix}$$

If the regression model {r(⋅; θ): X→Y|θϵΘ} includes the true model and it is denoted by θ*, the above formula 10 holds under a predetermined assumption. However, in the actual situations, since the true distribution F is unknown, in order to calculate an evaluator θ-hat of θ*, an empirical distribution F-hat (F superscripted by \hat{ }) defined by data is usually used. In this case, θ-hat is calculated as in the following formula 11.

$$\begin{matrix}[ Math 14 ] & \\ \hat{θ} = {arg min }_{θ} 𝔼 [ 𝓁 ( x , y , r ( x ; θ ) ) \vert x , y \sim \hat{F} ] & ( formula 11 )\end{matrix}$$

For example, in the case where (x, y)˜F are given by y˜N (w*^{T}x, σI), under a predetermined assumption, the following formula 12 holds.

$$\begin{matrix}[ Math 15 ] & \\ {w}^{*} = {arg min }_{w} 𝔼 [ ( y - {w}^{T} x ) \vert x , y \sim F ] & ( formula 12 )\end{matrix}$$

When w* is estimated from a sample {(xⱼ, yⱼ)}^{N}ⱼ₌₁ generated from F, the evaluation unit 20 calculates w-hat (w superscripted by \hat{ }) expressed by the following formula 13. In formula 13, F-hat is an empirical distribution defined by {(xⱼ, yⱼ)}^{N}ⱼ₌₁.

$$\begin{matrix} [ Math 16 ] & \\ \hat{w} = {arg min}_{w} \frac{1}{N} {\sum }_{j = 1}^{N} {( {y}_{j} - {w}^{T} {x}_{j} )}^{2} = 𝔼 [ ( y - {w}^{T} x ) \vert x , y \sim \hat{F} ] & ( formula 13 )\end{matrix}$$

Moreover, by defining T(F′) shown in the following formula 14 for any probability distribution F′ of X×Y, the evaluation unit 20 can obtain θ*=T(F) and θ-hat=T(F-hat).

$$\begin{matrix}[ Math 17 ] & \\ T ( {F}^{′} ) = {arg min }_{θ} 𝔼 [ 𝓁 ( x , y , r ( x : θ ) ) \vert x , y \sim {F}^{′} ] & ( formula 14 )\end{matrix}$$

The actual profit obtained by exemplary price optimization can be expressed as f(z(T(F-hat)), T(F)). Therefore, what is sought for here is the distribution expressed by the following formula 15. In formula 15, ε_{N}(F) represents a probability distribution of the empirical distribution given by independent N samples generated from F.

[Math 18]

ƒ(z(T(\hat{F})),T(F)),\acute{F}˜ε_{N}(F) (formula 15)

Here, it is to be noted that convergence toward F occurs where “F-hat˜ε_{N}(F)” is subject to N→∞. Specifically, the distribution function of F-hat converges almost certainly to the distribution function of F for each point. Since F is unknown, it is difficult to directly estimate the distribution of formula 15 described above. Therefore, instead of the distribution of the above formula 15, a distribution expressed by the following formula 16 is considered.

[Math 19]

ƒ(z(T(\hat{F})),T(F)),−ƒ(z(T(\hat{F})),T(\acute{F})),\acute{F}˜ε_{N}(F) (formula 16)

Formula 16 can be approximated by the following formula 17.

[Math 20]

ƒ(z(T(\check{\hat{F}})),T(\hat{F}))−ƒ(z(T(\hat{\check{F}})),T(\check{\hat{F}})),\check{\acute{F}}˜ε_{N}(\hat{F}) (formula 17)

The distribution expressed by the above formula 17 converges to the distribution expressed by the above formula 16 under some regularity conditions. Therefore, with sufficiently large N, formula 18 below is expected to be obtained.

[Math 21]

[symbol]

[ƒ(z(T(\hat{F})),T(F))]≈ƒ(z(T(\hat{F})),T(\grave{F}))+ [symbol] [ƒ(z(T(\hat{\grave{F}})),T(\hat{F}))−ƒ(z(T(\hat{\acute{F}})),T(\hat{\check{F}}))|\check{\acute{F}}˜ε_{N}(\hat{F})] (formula 18)

Note that it is assumed that T is secondary-compact-differentiable in F and that f(z, θ) is continuous for θ in every zϵZ. In this case, the distribution function expressed in the above formula 16 converges toward the distribution function of F at the order of:

[Math 22]

Oₚ(1/\sqrt{N})

That is, for any αϵR, the following formula 19 holds.

$$\begin{matrix} [ Math 23 ] & \\ P [ f ( z ( T ( \hat{F} ) ) , T ( F ) ) - f ( z ( T ( \hat{F} ) ) , T ( \hat{F} ) ) \leq a \vert \hat{F} \sim {ɛ}_{N} ( F ) ] - P [ f ( z ( T ( \hat{\hat{F}} ) ) , T ( \hat{F} ) ) - f ( z ( T ( \hat{\hat{F}} ) ) , T ( \hat{\hat{F}} ) ) \leq a \vert \hat{\hat{F}} \sim {ɛ}_{N} ( \hat{F} ) ] = {O}_{p} ( \frac{1}{\sqrt{N}} ) & ( formula 19 )\end{matrix}$$

Furthermore, in the case where it is assumed that T is secondary-compact-differentiable in F and that f(z, θ) is continuous for θ in every zϵZ., the following formula 20 is obtained.

$$\begin{matrix} [ Math 24 ] & \\ 𝔼 [ f ( z ( T ( \hat{F} ) ) , T ( F ) ) \vert \hat{F} \sim {ɛ}_{N} ( F ) ] - 𝔼 [ f ( z ( T ( \hat{F} ) ) , T ( \hat{F} ) ) + 𝔼 [ f ( z ( T ( \hat{\hat{F}} ) ) , T ( \hat{F} ) ) - f ( z ( T ( \hat{\hat{F}} ) ) , T ( \hat{\hat{F}} ) ) \vert \hat{\hat{F}} \sim {ɛ}_{N} ( \hat{F} ) ] \vert \hat{F} \sim {ɛ}_{N} ( F ) ] = {O}_{p} ( \frac{1}{\sqrt{N}} ) & ( formula 20 )\end{matrix}$$

Note that in the case of an order of random variables {Xₙ}, Xₙ=Oₚ(aₙ) provides the following formula 21.

[Math 25]

∀_{ϵ}>0,∃Mϵ [symbol] ,∀nϵ [symbol] ,P[|Xₙ/zₙ|>M]≤ϵ (formula 21)

The output unit 30 outputs an evaluation result. Specifically, the output unit 30 outputs an evaluation result calculated by the right side of the above formula 18.

The input unit 10, the evaluation unit 20, and the output unit 30 are implemented by a CPU of a computer operating in accordance with a program (evaluation program). For example, the program is stored in the storage unit 40, and the CPU may read the program and operate as the input unit 10, the evaluation unit 20, and the output unit 30 according to the program.

Alternatively, each of the input unit 10, the evaluation unit 20, and the output unit 30 may be implemented by separate dedicated hardware. Furthermore, the storage unit 40 is implemented by, for example, a magnetic disk.

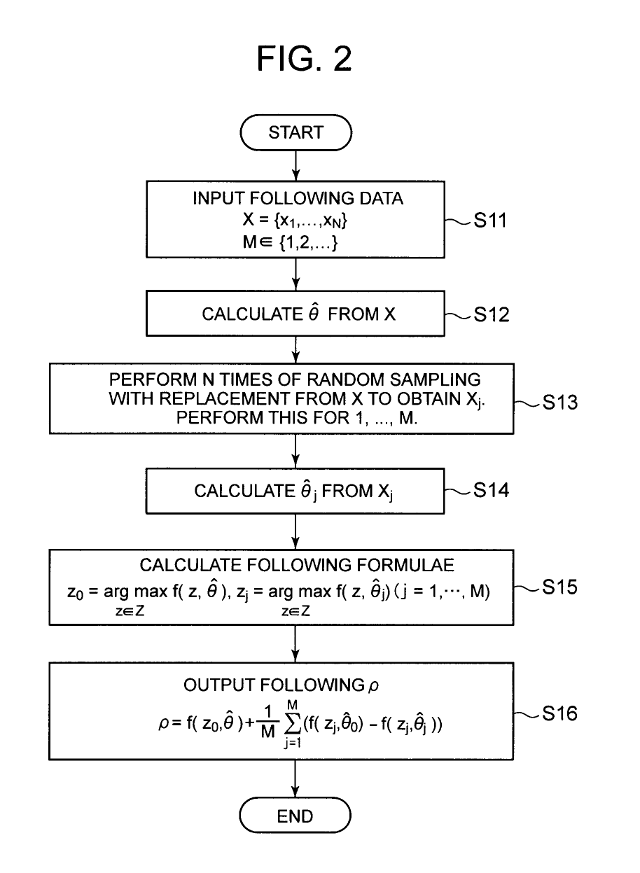

Next, the operation of the evaluation system of the present exemplary embodiment will be described. FIG. 2 depicts a flowchart illustrating exemplary operation of the evaluation system of the present exemplary embodiment.

First, the input unit 10 inputs N samples X={x₁, . . . , x_{N}} and Mϵ{1, 2, . . . } (step S11). Here, for j=1, . . . , M, let Xⱼ based on the bootstrap method be N random samples from X.

The evaluation unit 20 calculates the estimated value θ-hat having asymptotic normality from X (step S12). The evaluation unit 20 performs N times of random sampling with replacement from X to obtain Xⱼ. This is performed for j=1, 2, . . . , M (step S13). Likewise, the evaluation unit 20 calculates θⱼ-hat from Xⱼ (step S14). Then, the evaluation unit 20 calculates z in the following formula 22 (step S15). That is, the evaluation unit 20 repeats the calculation of z for M times.

$$\begin{matrix}[ Math 26 ] & \\ {z}_{0} = {arg max}_{z ∈ Z} f ( z , \hat{θ} ) , \\ {z}_{j} = {arg max}_{z ∈ Z} f ( z , {\hat{θ}}_{j} ) ( j = 1 , … , M ) & ( formula 22 )\end{matrix}$$

The output unit 30 outputs p expressed by the following formula 23 (step S16).

$$\begin{matrix}[ Math 27 ] & \\ p = f ( {z}_{0} , \hat{θ} ) + \frac{1}{M} {\sum }_{j = 1}^{M} ( f ( {z}_{j} , {\hat{θ}}_{0} ) - f ( {z}_{j} , {\hat{θ}}_{j} ) ) & ( formula 23 )\end{matrix}$$

Note that the theoretical guarantee of the operation exemplified in FIG. 2 is shown in the above formula 20.

As described above, in the present exemplary embodiment, the evaluation unit 20 evaluates the optimal solution calculated from the prediction model in consideration of bias generated between evaluation based on the prediction model and evaluation based on the true model. Therefore, the optimal solution based on the prediction can be evaluated theoretically without generating bias.

Specifically, the evaluation unit 20 calculates zⱼ as shown in the above formula 22 and calculates the difference between f(zⱼ, θ₀-hat) and f(zⱼ, θⱼ-hat) (specifically, the average of the total sums of the differences) as the bias of evaluation values of the true model and the prediction model. Therefore, it is theoretically possible to prevent occurrence of the bias between the two.

Next, a variation of the present exemplary embodiment will be described. In the present variation, an output unit 30 outputs a confidence interval of evaluation values. Let G be the distribution function of formula 16. In this case, the following formula 24 holds for αϵ(0, 1).

[Math 28]

P[ƒ(z(T(\hat{F})),T(F))−ƒ(z(T(\hat{F})),T(\hat{F}))ϵ[G⁻¹((1−α)/2),G⁻¹((1+α)/2)]]

=P[ƒ(z(T(F̊)),T(F̅))+G⁻¹((1−α)/2)≤ƒ(z(T(\hat{F})),T(F))≤ƒ(z(T(\check{F})),T(\hat{F}))+G⁻¹((1+α)/2)]=α (formula 24)

Under the observation that the distribution expressed by formula 17 converges to the distribution expressed by formula 16, the evaluation confidence interval of f(z(θ-hat), θ*) can be deemed as expressed by the following formula 25. In formula 25, G-hat (G superscripted by \hat{ }) represents the distribution function expressed by formula 17.

[Math 29]

P[ƒ(z(T(\hat{F})),T(\hat{F}))+\check{G}⁻¹((1−α)/2)≤ƒ(z(T(\acute{F})),T(F))≤ƒ(z(T(\hat{F})),T(\acute{F}))+Ġ⁻¹((1+α)/2)]≈α (formula 25)

In fact, formula 20 ensures that the left side converges to α at the order of:

[Math 30]

Oₚ(1/\sqrt{N})

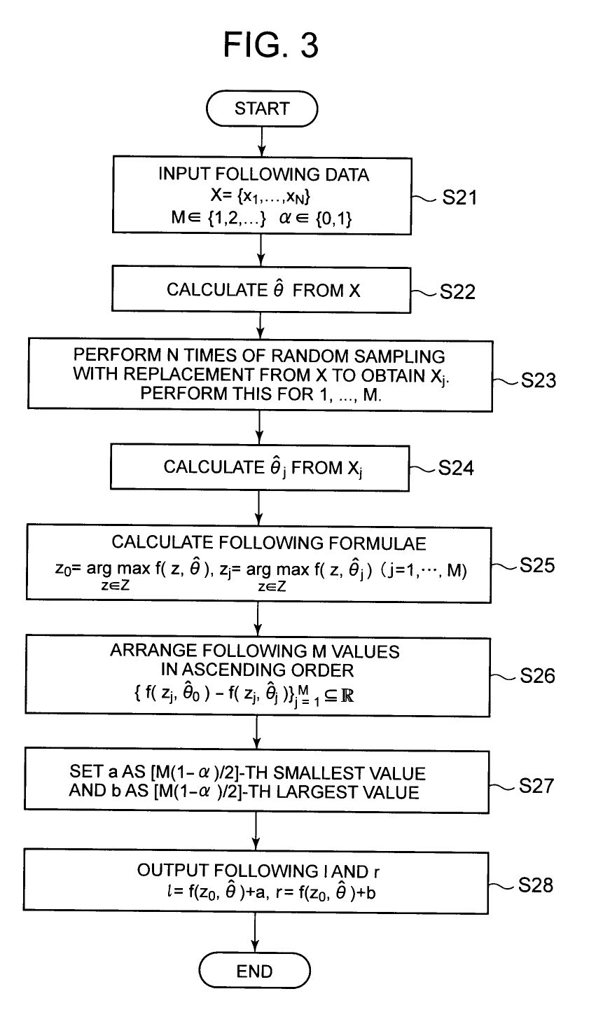

These can be summarized in algorithm depicted in FIG. 3. FIG. 3 depicts a flowchart illustrating exemplary operation of the evaluation system of the present variation.

First, an input unit 10 inputs N samples X={x₁, . . . , x_{N}}, Mϵ{1, 2, . . . }, and αϵ(0, 1) (step S21). Moreover, like in the first exemplary embodiment, let Xⱼ be N random (bootstrap) samples from X for j=1, . . . , M.

An evaluation unit 20 calculates an estimated value θ-hat having asymptotic normality from X (step S22). The evaluation unit 20 performs N times of random sampling with replacement from X to obtain Xⱼ. This is performed for j=1, 2, . . . , M (step S23). The evaluation unit 20 also calculates θⱼ-hat from Xⱼ (step S24). Then, the evaluation unit 20 calculates z in the following formula 26 (step S25). That is, the evaluation unit 20 repeats the calculation of z for M times.

$$\begin{matrix}[ Math 31 ] & \\ {z}_{0} = {arg max}_{z ∈ Z} f ( z , \hat{θ} ) , {z}_{j} = {arg max}_{z ∈ Z} f ( z , {\hat{θ}}_{j} ) \\ ( j = 1 , … , M ) & ( formula 26 )\end{matrix}$$

Next, the evaluation unit 20 arranges the following M values in the ascending order (step S26).

[Math 32]

{ƒ(zⱼ,\hat{θ}₀)−ƒ(zⱼ,\hat{θ}ⱼ)}ⱼ₌₁^{M}⊆

[symbol]

Then, the evaluation unit 20 sets a as the ceil (M(1−α)/2)-th smallest value and b as the ceil(M(1−α)/2)-th largest value (step S27). Note that ceil( ) represents a ceiling function.

The output unit 30 outputs a confidence interval [l, r] of 100α% of f(z(θ-hat), θ*) (step S28). The symbols l and r are expressed by the following formula 27.

[Math 33]

l=ƒ(z₀,\hat{θ})+α,r=ƒ(z₀,\hat{θ})+b (formula 27)

In this manner, the evaluation unit 20 determines the order of evaluation differences and outputs, as an evaluation interval, the minimum value and the maximum value (ceil(M(1−α)/2)−th smallest and largest values) of evaluation differences included in the order corresponding to a specified range. This allows a more reliable evaluation result to be obtained.

### Second Exemplary Embodiment

Next, a second exemplary embodiment of an evaluation system of the present invention will be described. In the present exemplary embodiment, in addition to the assumptions of the first exemplary embodiment, the following contents are assumed. First, in the present exemplary embodiment, f(z, θ) represents affine transformation for θ, and it is assumed that, for example, the following formula 28 hold.

[Math 34]

[symbol]

α:Z→ [symbol] , [symbol] b:Z→ [symbol] ,ƒ(z,θ)θ^{T}α(z)+b(z) (formula 28)

It is assumed that there exists Σ* such that the evaluator θ-hat satisfies “θ-hat˜N(θ*, Σ*)” and that for any γ>1, “θ-hat-hat˜N(θ*, γΣ*)” (θ-hat-hat is θ with two superscripts \hat{ }) can be observed.

Here, in the case where θ-hat is an estimated value having asymptotic normality, for example, there exists V as expressed in the following formula 29.

[Math 35]

\sqrt{N}(\hat{θ}−θ*)→^{d}N(0,V) (formula 29)

In formula 29, N denotes the number of samples and →^{d} represents convergence in the distribution. Therefore, this assumption holds in an asymptotic sense. On the basis of the above assumptions, an exemplary embodiment of the present invention will be described with reference to the drawings. Note that a configuration of the evaluation system of the present exemplary embodiment is similar to that of the first exemplary embodiment.

First, for γ≥0, φ(γ) and η(γ) are defined as in formulae 30 and 31 below. In formulae 30 and 31, δ˜N(0, Σ*). The purpose of this exemplary embodiment is to estimate η(1).

[Math 36]

ϕ(γ)= [symbol] _{δ}[ƒ(z(θ*,θ*+γδ),θ*+δ)] (formula 30)

η(γ)= [symbol] _{δ}[ƒ(z(θ*,θ*+γδ),θ*)] (formula 31)

Here, φ(γ) is differentiable for all γ>0, and its derivative φ′(γ) satisfies the following formula 32.

[Math 37]

η(γ)=ϕ(γ)−γϕ′(γ) (formula 32)

In the case where a certain random sample θ-hat˜N(θ*, Σ*) is obtained from the above formula 32 and θₕ-hat˜N(θ*, (1+h)²Σ²) is further obtained, the value of formula 33 is the evaluator of η(1).

$$\begin{matrix}[ Math 38 ] & \\ p ( \hat{θ} , {\hat{θ}}_{h} ) := \frac{1 + h}{h} {max}_{z ∈ Z} f ( z , \hat{θ} ) - \frac{1}{h} {max}_{z ∈ Z} f ( z , {\hat{θ}}_{h} ) & ( formula 33 )\end{matrix}$$

Here, it is assumed that θ-hat˜N (θ*, Σ*) and θₕ-hat˜N(θ*, (1+h)²Σ*) hold. In this case, the following formula 34 holds.

$$\begin{matrix} [ Math 39 ] & \\ {lim}_{h \to 0} {𝔼}_{\hat{θ} , {\hat{θ}}_{h}} [ \frac{1 + h}{h} {max}_{z ∈ Z} f ( z , \hat{θ} ) - \frac{1}{h} {max}_{z ∈ Z} f ( z , {\hat{θ}}_{h} ) ] = {𝔼}_{\hat{θ}} [ f ( z ( \hat{θ} ) , {θ}^{*} ) ] & ( formula 34 )\end{matrix}$$

Hereinafter, two types of situations are assumed. As a first assumption (noise addition method), it is assumed that a random sample θ-hat˜N(θ*, Σ*) is obtained. In the case where Σ* is known, the evaluation unit 20 can obtain θₕ-hat that follows N(0, (1+h)²) by sampling δ from N(0, Σ*) and establishing:

[Math 40]

\hat{θ}ₕ=\hat{θ}+\sqrt{(1+h²)−1}δ

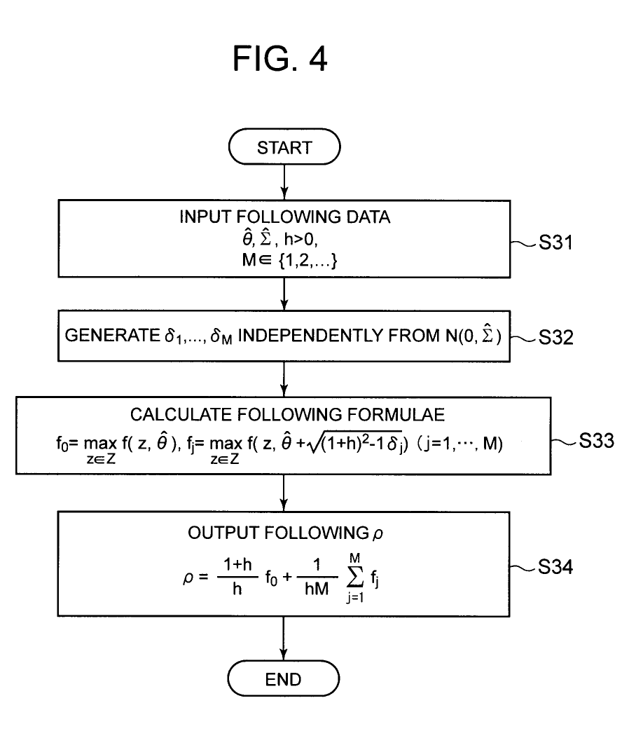

Hereinafter, the operation of calculating ρ on the basis of the first assumption will be described. FIG. 4 is a flowchart depicting an operation example of the evaluation system in the case where the first assumption is made in the present exemplary embodiment.

First, the input unit 10 inputs θ-hat that is larger than 0, Σ-hat (Σ superscripted by \hat{ }), and h as well as Mϵ{1, 2, . . . } (step S31). The evaluation unit 20 generates δ₁, . . . , δ_{M} independently from N(0, Σ-hat) (step S32). Then, the evaluation unit 20 calculates f expressed in the following formula 35 (step S33). That is, the evaluation unit 20 repeats the calculation of f for M times.

$$\begin{matrix}[ Math 41 ] & \\ {f}_{0} = {max}_{z ∈ Z} f ( z , \hat{θ} ) , \\ {f}_{j} = {max}_{z ∈ Z} f ( z , \hat{θ} + \sqrt{{( 1 + h )}^{2} - 1} {δ}_{j} ) \\ ( j = 1 … M ) & ( formula 35 )\end{matrix}$$

The output unit 30 outputs ρ expressed by the following formula 36 (step S34).

$$\begin{matrix}[ Math 42 ] & \\ ρ = \frac{1 + h}{h} {f}_{0} + \frac{1}{hM} {\sum }_{j = 1}^{M} {f}_{j} & ( formula 36 )\end{matrix}$$

As described above, the evaluation unit 20 generates a model obtained by adding noise to the prediction model and calculates an average of evaluation values calculated from the model as bias of evaluation values between the true model and the prediction model. With such a configuration, an optimal solution based on prediction can be evaluated theoretically without generating a bias.

Next, a second assumption will be explained. As a second assumption (method based on resampling), it is assumed that θ-hat represents a maximum likelihood estimation (MLE) calculated from N samples. Let θ₁-hat be an MLE calculated from [N/(1+h)²Σ] samples. In this case, θ-hat and θₕ-hat asymptotically approach toward N (θ*, I(θ*)⁻¹/N) and N(θ*, (1+h)²I(θ*)⁻¹/N), respectively.

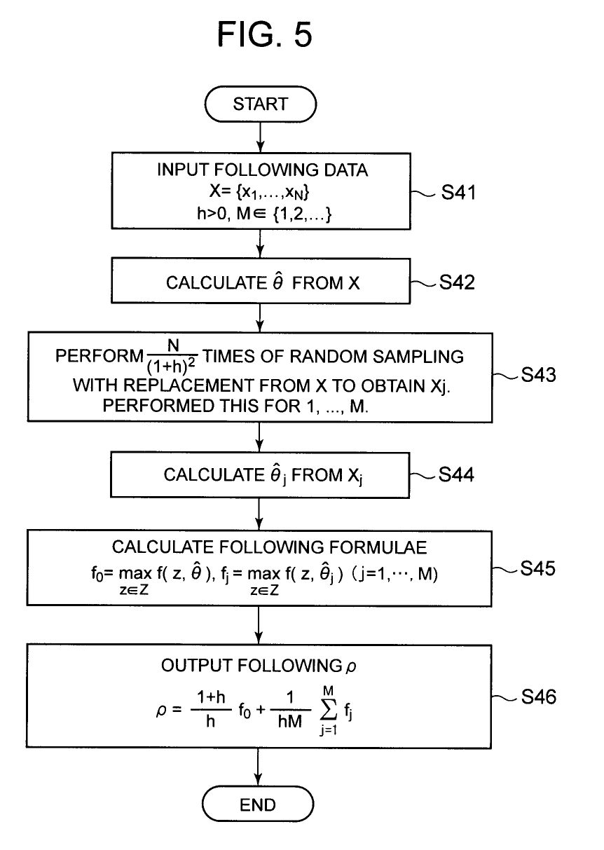

Hereinafter, the operation of calculating p on the basis of the second assumption will be described. FIG. 5 is a flowchart depicting an operation example of the evaluation system in the case where the second assumption is made in the present exemplary embodiment.

First, the input unit 10 inputs N samples X={x₁, . . . , x_{N}}, h(>0), and Mϵ{1, 2, . . . } (step S41). Let Xⱼ be [N/(1+h)²] random samples from X for j=1, . . . , M.

The evaluation unit 20 calculates an estimated value θ-hat having asymptotic normality from X (step S42). The evaluation unit 20 performs [N/(1+h)²] times of random sampling from X to obtain Xⱼ. This is performed for j=1, 2, . . . , M (step S43). The evaluation unit 20 further calculates θⱼ-hat from Xⱼ (step S44). Then, the evaluation unit 20 calculates f expressed in the following formula 37 (step S45). That is, the evaluation unit 20 repeats the calculation of f for M times.

$$\begin{matrix}[ Math 43 ] & \\ {f}_{0} = {max}_{z ∈ Z} f ( z , \hat{θ} ) , \\ {f}_{j} = {max}_{z ∈ Z} f ( z , {\hat{θ}}_{j} ) ( j = 1 … M ) & ( formula 37 )\end{matrix}$$

The output unit 30 outputs ρ expressed by the following formula 38 (step S46).

$$\begin{matrix}[ Math 44 ] & \\ ρ = \frac{1 + h}{h} {f}_{0} + \frac{1}{hM} {\sum }_{j = 1}^{M} {f}_{j} & ( formula 38 )\end{matrix}$$

As described above, the evaluation unit 20 performs evaluation based on the true model from the linear sum of the maximum values of evaluation values calculated from θ-hat and the maximum values of evaluation values calculated from θⱼ-hat (specifically, the average of total sums of the maximum values). With such a configuration, an optimal solution based on prediction can be evaluated theoretically without generating a bias.

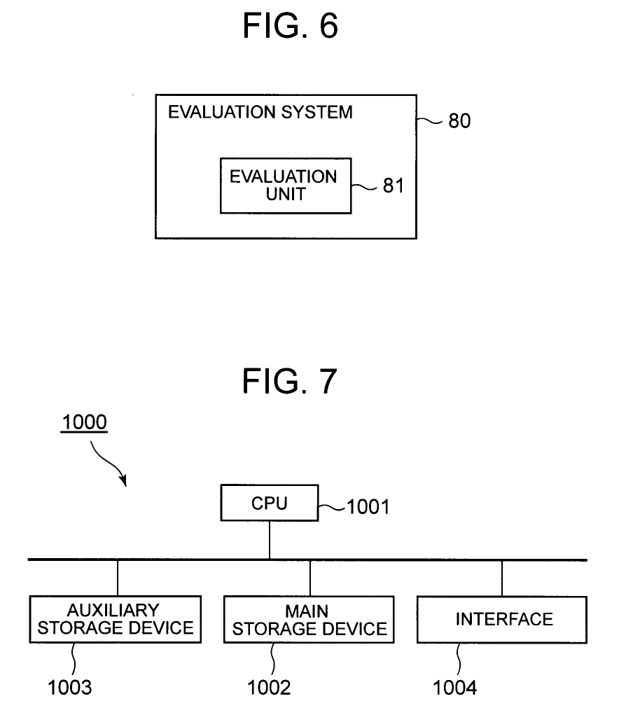

Next, an overview of the present invention will be described. FIG. 6 depicts a block diagram illustrating an overview of an evaluation system of the present invention. The evaluation system 80 according to the present invention (e.g. evaluation system 100) includes the evaluation unit 81 (e.g. evaluation unit 20) which evaluates, when there is a prediction model (e.g. θ-hat) estimated using data generated from the true model (e.g. θ*), the optimal solution calculated from the prediction model in consideration of bias (e.g. bias expressed in the above formula 8) generated between evaluation based on the prediction model and evaluation based on the true model.

With such a configuration, the optimal solution based on prediction can be evaluated theoretically without generating bias.

That is, in the present invention, the phenomenon that bias occurs when a prediction model is generated on the basis of data generated from the true model and the optimal solution is calculated from the prediction model to evaluate the result by the prediction model is modeled into an abstract model as expressed by the above formula 6, and then the evaluation unit 81 evaluates the optimal solution. Thus, this can theoretically prevent occurrence of bias between the optimal solution evaluated by the prediction model and the optimal solution evaluated by the true model.

Alternatively, the evaluation unit 81 may select, by a bootstrap method, from the data used for generation of the prediction model, estimate a first model (e.g. θⱼ-hat) using the selected data, and calculate, as bias of evaluation values between the true model and the prediction model, an evaluation difference which is a difference between first evaluation obtained by evaluating the optimal solution, calculated from the first model, by the first model (e.g. f(zⱼ, θⱼ-hat)) and second evaluation (e.g. f(zⱼ, θ₀-hat)) obtained by evaluating the optimal solution by the prediction model.

Moreover, the evaluation unit 81 may estimate a plurality of first models and calculate, as bias of evaluation values between the true model and a model for prediction, an average of the total sums of evaluation differences which are differences between first evaluation obtained by evaluating optimal solutions, calculated from the first models having been estimated, by the first models and second evaluation obtained by evaluating the optimal solutions by the prediction model.

Furthermore, the evaluation unit 81 may rearrange the evaluation differences calculated each time a first model is estimated to determine the order of the evaluation differences and output, as an evaluation interval, the minimum value and the maximum value of the evaluation differences included in the order corresponding to a specified range.

Alternatively, the evaluation unit 81 may generate a second model (for example, θₕ-hat under the first assumption of the second exemplary embodiment) obtained by adding noise to the prediction model and perform evaluation based on the true model from the linear sum of the maximum values of evaluation values calculated from the second model and the maximum values of evaluation values calculated from the prediction model.

Further alternatively, the evaluation unit 81 may estimate a third model (for example, θⱼ-hat under the second assumption of the second exemplary embodiment) using at least a part of the data used for generation of the prediction model and perform evaluation based on the true model from the linear sum of the maximum values of evaluation values calculated from the prediction model and the maximum values of evaluation values calculated from the third model.

In this case, the evaluation unit 81 may estimate a plurality of third models and perform evaluation based on the true model from the linear sum of the maximum values of evaluation values calculated from the prediction model and the average of the total sums of the maximum values of evaluation values calculated from the third model.

FIG. 7 depicts a schematic block diagram illustrating a configuration of a computer according to at least one of the exemplary embodiments. A computer 1000 includes a CPU 1001, a main storage device 1002, an auxiliary storage device 1003, and an interface 1004.

Each of the above-described model estimation devices is mounted on the computer 1000. The operation of the respective processing units described above is stored in the auxiliary storage device 1003 in the form of a program (evaluation program). The CPU 1001 reads the program from the auxiliary storage device 1003, deploys the program in the main storage device 1002, and executes the above processing according to the program.

Note that at least in one of the exemplary embodiments, the auxiliary storage device 1003 is an exemplary non-transitory physical medium. Other examples of non-transitory physical medium include a magnetic disc, a magneto-optical disk, a CD-ROM, a DVD-ROM, and a semiconductor memory that are connected via the interface 1004. In the case where the program is distributed to the computer 1000 by a communication line, the computer 1000 distributed with the program may deploy the program in the main storage device 1002 to execute the processing described above.

Incidentally, the program may implement a part of the functions described above. The program may implement the aforementioned functions in combination with another program stored in the auxiliary storage device 1003 in advance, that is, the program may be a differential file (differential program).

The present invention has been described above with reference to the exemplary embodiments and the examples; however, the present invention is not limited to the above exemplary embodiments or the examples. The configuration or details of the present invention may include various variations that can be understood by a person skilled in the art within the scope of the present invention.

This application claims priority based on Japanese Patent Application No. 2016-211438, filed on Oct. 28, 2016, discloser of which is incorporated herein in its entirety.

### REFERENCE SIGNS LIST

10 Input unit
20 Evaluation unit
30 Output unit

1. An evaluation system comprising:
a hardware including a processor; and
an evaluation unit, implemented by the processor, which evaluates, when there is a prediction model estimated using data generated from a true model, an optimal solution calculated from the prediction model in consideration of bias generated between evaluation based on the prediction model and evaluation based on the true model.

2. The evaluation system according to claim 1,
wherein the evaluation unit selects, by a bootstrap method, from the data used for generation of the prediction model, estimates a first model using the selected data, and calculates, as bias of evaluation values between the true model and the prediction model, an evaluation difference which is a difference between first evaluation obtained by evaluating an optimal solution, calculated from the first model, by the first model and second evaluation obtained by evaluating the optimal solution by the prediction model.

3. The evaluation system according to claim 2,
wherein the evaluation unit estimates a plurality of first models and calculate, as the bias of the evaluation values between the true model and the prediction model, an average of total sums of evaluation differences which are differences between first evaluation obtained by evaluating optimal solutions, calculated from the first models having been estimated, by the first models and second evaluation obtained by evaluating the optimal solutions by the prediction model.

4. The evaluation system according to claim 3,
wherein the evaluation unit rearranges the evaluation differences calculated each time one of the first models is estimated to determine an order of the evaluation differences and outputs, as an evaluation interval, a minimum value and a maximum value of the evaluation differences included in the order corresponding to a specified range.

5. The evaluation system according to claim 1,
wherein the evaluation unit generates a second model obtained by adding noise to the prediction model and performs evaluation based on the true model from a linear sum of maximum values of evaluation values calculated from the second model and maximum values of evaluation values calculated from the prediction model.

6. The evaluation system according to claim 1,
wherein the evaluation unit estimates a third model using at least a part of the data used for generation of the prediction model and performs evaluation based on the true model from a linear sum of maximum values of evaluation values calculated from the prediction model and maximum values of evaluation values calculated from the third model.

7. The evaluation system according to claim 6,
wherein the evaluation unit estimates a plurality of third models and performs evaluation based on the true model from a linear sum of the maximum values of the evaluation values calculated from the prediction model and an average of total sums of maximum values of evaluation values calculated from the third models.

8. An evaluation method comprising:
evaluating, when there is a prediction model estimated using data generated from a true model, an optimal solution calculated from the prediction model in consideration of bias generated between evaluation based on the prediction model and evaluation based on the true model.

9. The evaluation method according to claim 8, comprising
selecting, by a bootstrap method, from the data used for generation of the prediction model,
estimating a first model using the selected data, and
calculating, as bias of evaluation values between the true model and the prediction model, an evaluation difference which is a difference between first evaluation obtained by evaluating an optimal solution, calculated from the first model, by the first model and second evaluation obtained by evaluating the optimal solution by the prediction model.

10. A non-transitory computer readable information recording medium storing an evaluation program, when executed by a processor, that performs a method for:
evaluating, when there is a prediction model estimated using data generated from a true model, an optimal solution calculated from the prediction model in consideration of bias generated between evaluation based on the prediction model and evaluation based on the true model.

11. The non-transitory computer readable information recording medium according to claim 10, comprising
selecting, by a bootstrap method, from the data used for generation of the prediction model,
estimating a first model using the selected data, and
calculating, as bias of evaluation values between the true model and the prediction model, an evaluation difference which is a difference between first evaluation obtained by evaluating an optimal solution, calculated from the first model, by the first model and second evaluation obtained by evaluating the optimal solution by the prediction model.
